(19) United States
(12) Patent Application Publication
(10) Pub. No.: US 2019/0061249 A1
(43) Pub. Date: Feb. 28, 2019

(54) THREE-DIMENSIONAL PRINTER HAVING DOOR LOCK STRUCTURE

(71) Applicants: XYZPRINTING, INC., NEW TAIPEI CITY (TW); KINPO ELECTRONICS, INC., NEW TAIPEI CITY (TW)

(72) Inventors: Yang-Teh LEE, NEW TAIPEI CITY (TW); Jia-Yi JUANG, NEW TAIPEI CITY (TW); Yi-Chu HSIEH, NEW TAIPEI CITY (TW)

(21) Appl. No.: 15/861,666

(22) Filed: Jan. 3, 2018

(30) Foreign Application Priority Data
Aug. 31, 2017 (CN) 201710770677.7

(51) Int. Cl. B29C 64/25; B29C 64/153; E05B 43/00

(52) U.S. Cl. CPC B29C 64/25; B29C 67/0007; E05B 43/005; B29C 64/153

(57) ABSTRACT

A 3D printer having a door lock structure includes a housing, a door panel, a door lock structure, a coloring nozzle set, an actuator, and a controller. The door panel is pivotally connected to the housing. The door lock structure is arranged corresponding to the door panel and has a locking position and an unlocking position. The actuator is connected to the door lock structure and drives the door lock structure to lock or unlock the door panel. The controller is electrically connected to the actuator. The controller controls the actuator to drive the door lock structure to the locking position. The controller activates an unlocking mode after a predetermined time after the coloring nozzle set stops operating. In the unlocking mode, the controller controls the actuator to drive the door lock structure to the unlocking position.

### TECHNICAL FIELD

The technical field relates to a three-dimensional printer and, in particular, to a three-dimensional printer having a door lock structure.

### BACKGROUND

Three-dimensional (3D) printing is one of rapid formation techniques, which utilizes a movable platform to drive a platform to move, and then dispenses a powdered material such as metal powder or plastic powder, so that successive layers of the powdered material are joined to form a 3D object. At present, toys, mechanical parts or replacement human bones can be made by 3D printing, which makes 3D printing become increasingly popular.

However, 3D printing also involves a coloring printing mode in which a coloring nozzle is used to color a laminated object constituted by the powdered material, and a large amount of powder is generated during the coloring printing period. Powder is discharged to ambient environment and causes pollution if a door of the 3D printer is opened, during the printing period or shortly after printing stops, before the powder is reduced to an acceptable small amount. Therefore, there is a need for a 3D printer which prevents powder from polluting the environment by confining the powder in the 3D printer.

Accordingly, in order to solve the above disadvantage, the inventor studied related technology and provided a reasonable and effective solution in the present disclosure.

### SUMMARY

The present disclosure is directed to a three-dimensional printer having a door lock structure. By using the door lock structure, a door panel stays at a closed position. The door panel is not released until powder in a housing is drawn away after the coloring nozzle set stops operating, thereby preventing the powder from being discharged to the outside of a housing and thus maintaining good ambient air quality.

According to one embodiment of the present disclosure, a three-dimensional printer having a door lock structure is provided, comprising a housing, a door panel, a door lock structure, an actuator, a formation nozzle member, a coloring nozzle set, an exhaust fan structure, and a controller. The housing includes a chamber inside and an opening communicating with the chamber. The door panel is pivotally connected to the housing and is movable between a closed position which closes the opening and an open position which exposes the opening. The door lock structure is disposed corresponding to the door panel, and the door lock structure includes a locking position and an unlocking position. The actuator is connected to the door lock structure and drives the door lock structure to lock or unlock the door panel. The formation nozzle member is installed in the chamber and is movable therein, and the formation nozzle member is used to print a laminated object. The coloring nozzle set is installed in the chamber and is movable therein, and the coloring nozzle set is used to color the laminated object. The exhaust fan structure is assembled to the housing and communicates with the chamber, and the exhaust fan structure is used to draw air from the housing and discharge the air to the outside of the housing. The controller is electrically connected the actuator, the formation nozzle member, the coloring nozzle set, and the exhaust fan structure, wherein the control controls the actuator to drive the door lock structure to the locking position. When the door panel is at the closed position, the door lock structure locks the door panel, and the controller is allowed to activate a printing mode. The printing mode includes, by using the controller, controlling the formation nozzle member and the coloring nozzle set to perform three-dimensional printing and controlling the exhaust fan structure to keep operating. The controller activates an unlocking mode after a predetermined time after operation of the coloring nozzle set is stopped. In the unlocking mode, the controller controls the actuator to drive the door lock structure to the unlocking position to release the door panel.

A large amount of powder is generated during the printing mode, but the door lock structure locks the door panel to keep it at the closed position, thus preventing the door panel from being opened during the printing mode or shortly after the printing mode is ended, thereby preventing the powder from being discharged to the outside of the housing and maintaining good ambient air quality.

The door lock structure does not release the door panel until the powder inside the housing is discharged to the outside of the housing after the predetermined time after operation of the coloring nozzle set is stopped. Accordingly, the powder is prevented from being discharged to the outside of the housing, and good ambient air quality is maintained.

### BRIEF DESCRIPTION OF THE DRAWINGS

The disclosure will become more fully understood from the detailed description, and the drawings given herein below is for illustration only, and thus does not limit the disclosure, wherein:

FIG. 1 is a perspective assembled view illustrating a three-dimensional printer of the present disclosure;

FIG. 2 is a perspective exploded view illustrating a door lock structure according to the present disclosure;

FIG. 3 is a schematic view illustrating a door lock structure in use;

FIG. 4 is a diagram illustrating the three-dimensional printer;

FIG. 5 is a schematic view illustrating the three-dimensional printer in use;

FIG. 6 is another schematic view illustrating the door lock structure in use; and

FIG. 7 is another diagram illustrating the three-dimensional printer.

### DETAILED DESCRIPTION

Detailed descriptions and technical contents of the present disclosed example are illustrated below in conjunction with the accompanying drawings. However, it is to be understood that the descriptions and the accompanying drawings disclosed herein are merely illustrative and exemplary and not intended to limit the scope of the present disclosed example.

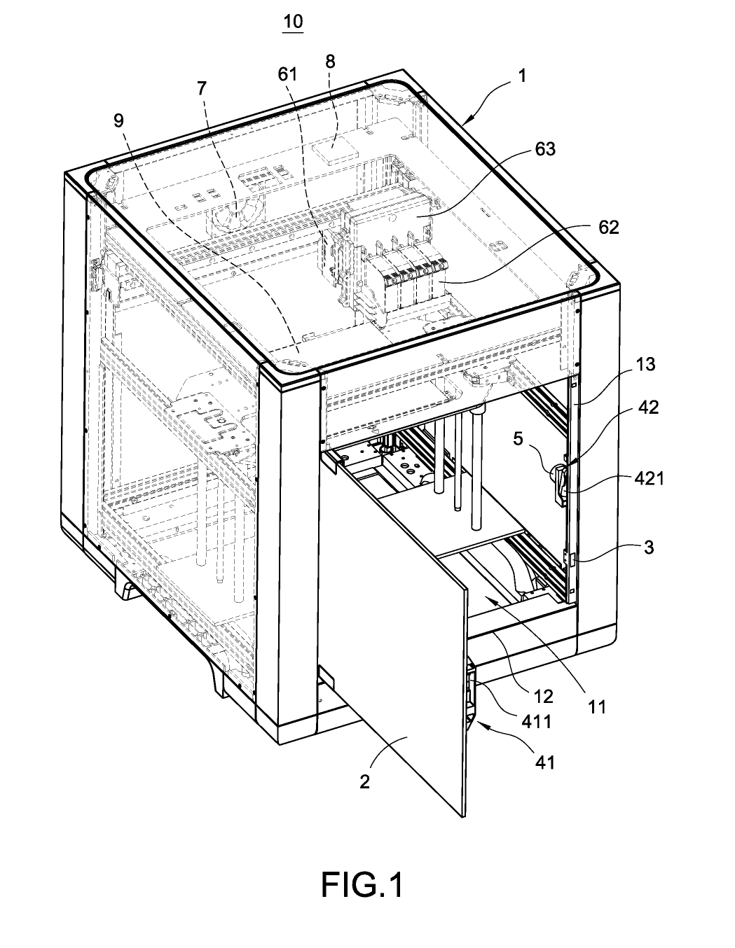

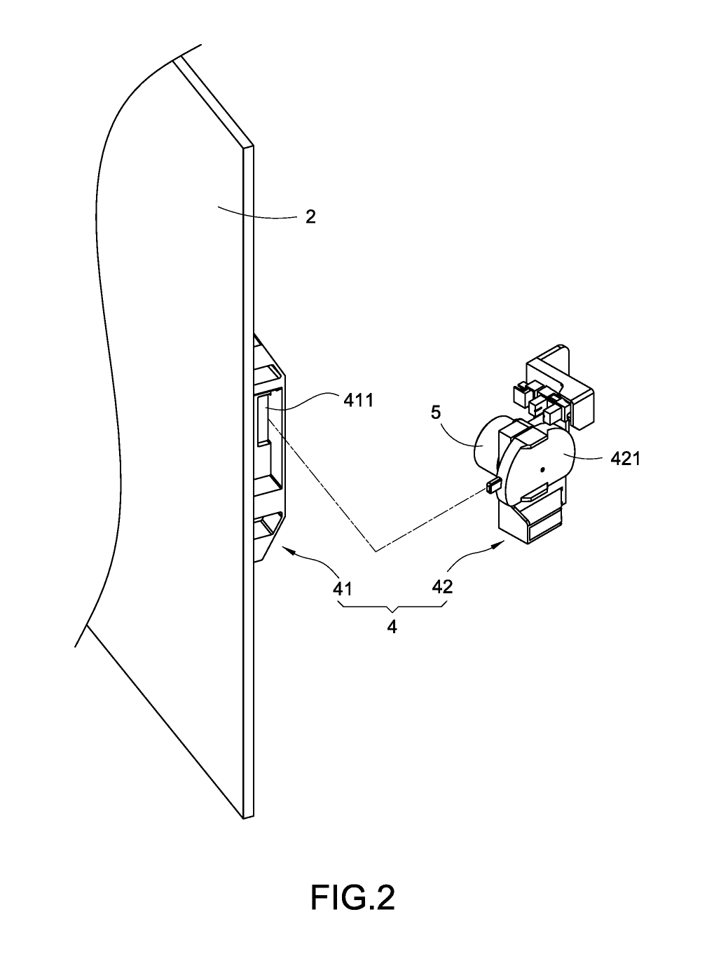

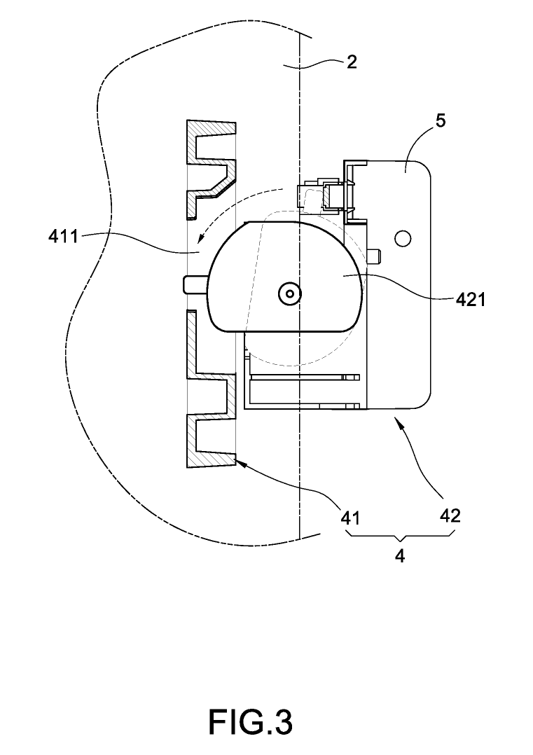

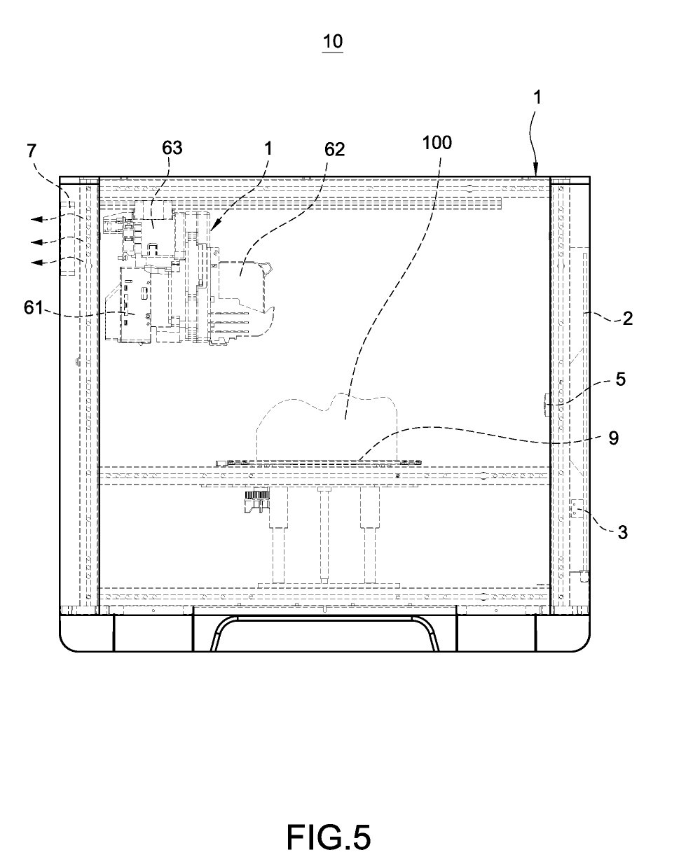

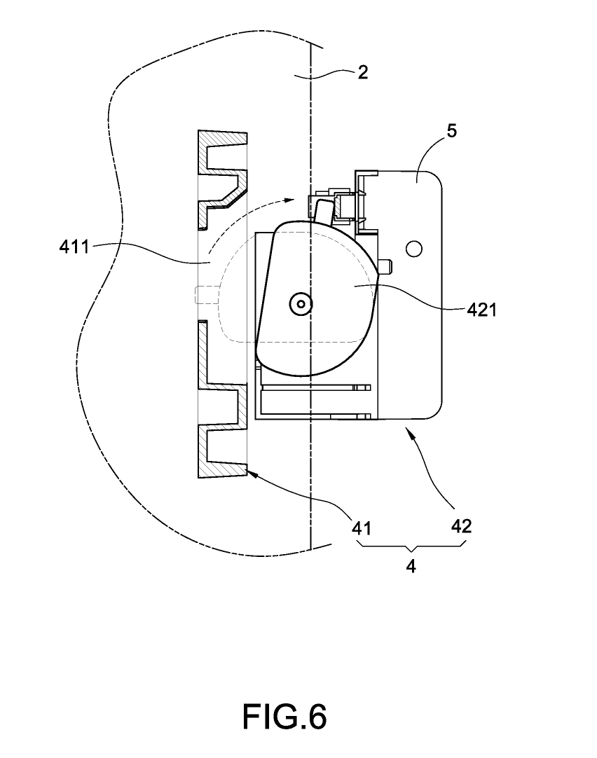

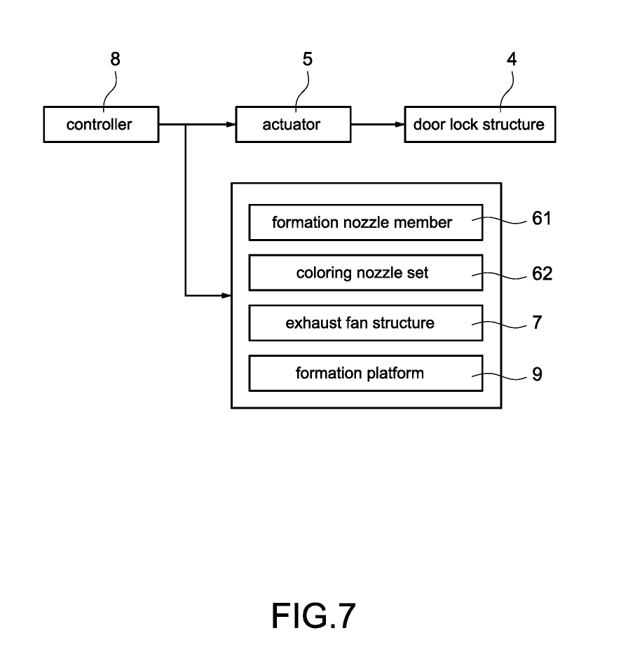

Referring to FIGS. 1 to 7, the present disclosure provides a three-dimensional printer having a door lock structure. The three-dimensional printer 10 includes a housing 1, a door panel 2, a door lock structure 4, an actuator 5, a formation nozzle member 61, a coloring nozzle set 62, an exhaust fan structure 7, and a controller 8.

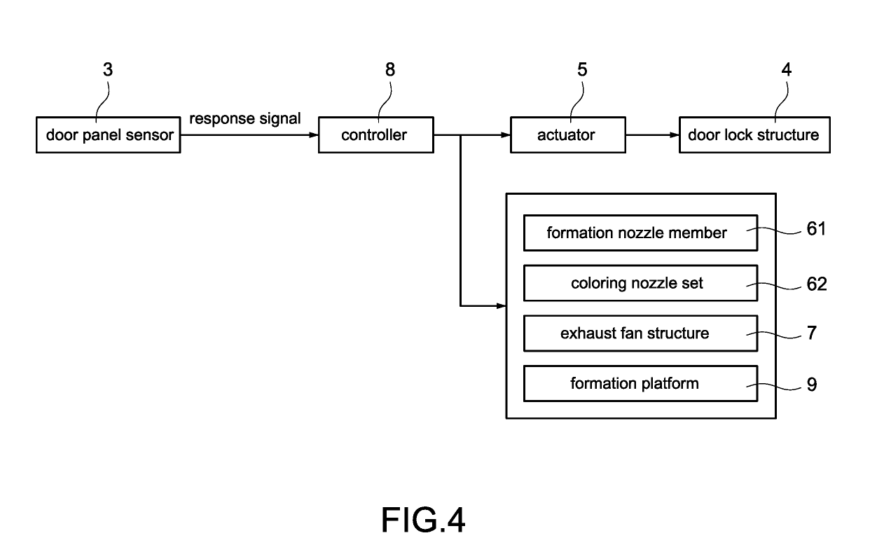

Referring to FIGS. 1 and 4, the housing 1 includes a chamber 11 inside and an opening 12 communicating with the chamber 11. A block plate 13 extends from one side of the opening 12 of the housing 1.

As shown in FIGS. 1 to 3, the door panel 2 is pivotally connected to the housing 1, the door panel 2 is movable between a closed position which closes the opening 12 and an open position which exposes the opening 12. When the door panel 2 is moved to the closed position, the door panel 2 is blocked by the block plate 13.

As shown in FIG. 1, the three-dimensional printer 10 further includes a door panel sensor 3 disposed corresponding to the door panel 2. The door panel sensor 3 is used to generate a response signal when the door panel sensor 3 senses that the door panel 2 is at the closed position. The door panel sensor 3 is fixed to the block plate 13; however, the present disclosure is not limited in this regard.

Referring to FIGS. 1 to 3, the door lock structure 4 is disposed corresponding to the door panel 2. The door lock structure 4 has a locking position and an unlocking position. The door lock structure 4 includes a lock hole element 41 fixed to the door panel 2 and a latch structure 42 fixed to the housing 1. The lock hole element 41 has a lock hole 411. The latch structure 42 has a pivot member 421. In the locking position, the pivot member 421 is inserted in the lock hole 411. In the unlocking position, the pivot member 421 is detached from the lock hole 411. In the present embodiment, the latch structure 42 is fixed to the block plate 13; however, the present disclosure is not limited in this regard.

Referring to FIGS. 1 to 3, the actuator 5 is connected to the door lock structure 4 and drives the door lock structure 4 to lock or unlock the door panel 2. In detail, the actuator 5 can drive the pivot member 421 to be inserted in the lock hole 411 to thereby lock the door panel 2. The actuator 5 can drive the pivot member 421 to be detached from the lock hole 411 to release the door panel 2. In the present embodiment, the actuator 5 is a motor; however, the present disclosure is not limited in this regard.

As shown in FIGS. 1 and 4, the formation nozzle member 61 and the coloring nozzle set 62 are installed in the chamber 11 and movable therein. The formation nozzle member 61 is used to print a laminated object 100. The coloring nozzle set 62 is used to color the laminated object 100. In the present embodiment, the three-dimensional printer 10 further includes a drive base 63. The formation nozzle member 61 and the coloring nozzle set 62 are fixed to the drive base 63, so that the formation nozzle member 61 and the coloring nozzle set 62 are movable along with the drive base 63; however, the present disclosure is not limited in this regard, which means the formation nozzle member 61 and the coloring nozzle set 62 can move independently.

As shown in FIGS. 1 and 4, the exhaust fan structure 7 is assembled to the housing 1 and communicates with the chamber 11. The exhaust fan structure 7 is used to draw air from inside the housing 1 and discharge the air to the outside of the housing 1.

As shown in FIG. 1, the controller 8 is electrically connected to the door panel sensor 3, the actuator 5, the formation nozzle member 61, the coloring nozzle set 62, and the exhaust fan structure 7.

As shown in FIGS. 1 and 4, the three-dimensional printer 10 further includes a formation platform 9. The formation platform 9 is installed in the chamber 11 and is electrically connected to the controller 8, and the controller 8 controls the formation platform 9 to move from an original position.

As shown in FIGS. 1 to 4 illustrating the three-dimensional printer 10 in use, the door panel sensor 3 senses that the door panel 2 is at the closed position and generates a response signal.

After the controller 8 receives the response signal, the controller 8 controls the actuator 5 to drive the door lock structure 4 to the locking position. When the door panel 2 is at the closed position, the controller 8 activates a printing mode. The printing mode can be carried out via two embodiments. FIGS. 1 to 4 show the printing mode carried out via the first embodiment. To be specific, in the printing mode, the controller 8 controls the formation nozzle member 61 and the coloring nozzle set 62 to perform three-dimensional printing, keeps the exhaust fan structure 7 in operation, and activates the formation platform 9, so that the laminated object 100 is laminated layer by layer on the formation platform 9 via the formation nozzle member 61, the coloring nozzle set 62 then colors the laminated object 100. The coloring nozzle set 62 generates a large amount of powder during the printing mode. The door panel 2 is locked by the door lock structure 4 to keep in the closed position, so as to ensure that the powder is not discharged to the outside of the housing 1 during the printing mode or shortly after the printing mode is ended, thus maintaining good air quality around the three-dimensional printer 10.

Please refer to FIGS. 1, 5 to 7 showing the three-dimensional printer 10 in use according to another embodiment. After the printing mode of the first embodiment is ended, the controller 8 controls the formation nozzle member 61 and the coloring nozzle set 62 to stop operating, and controls the formation platform 9 to return to its original position. Then, an unlocking mode is activated after a predetermined time after the controller 8 determines that the coloring nozzle set 62 stops operating. From when the coloring nozzle set 62 stops operating to the predetermined time, the controller 8 controls the exhaust fan structure 7 to keep operating, so that the powder inside the housing 1 is drawn and discharged to the outside of the housing 1 by the exhaust fan structure 7. At last, the unlocking mode is activated, wherein the controller 8 controls the actuator 5 to drive the door lock structure 4 to the unlocking position, so that the door panel 2 is released, and the door panel 2 is allowed to move to the open position. Accordingly, from when the coloring nozzle set 62 stops operating to the predetermined time, the powder inside the housing 1 is continuously drawn and discharged to the outside of the housing 1, and the door lock structure 4 does not release the door panel until the amount of powder inside the housing 1 is acceptably small, thereby preventing the powder from being discharged to the outside of the housing 1 and ensuring good ambient air quality.

After the predetermined time after the coloring nozzle set 62 stops operating, the controller 8 controls the exhaust fan structure 7 to stop operating. Alternatively, the exhaust fan structure 7 is kept in operation after the three-dimensional printer 10 is powered on, which means, before or after the printing mode, the exhaust fan structure 7 keeps drawing the air inside the housing 1 and discharge the air to the outside of the housing 1.

According to the first embodiment for carrying out the printing mode, the predetermined time is calculated as follows. A fixed time is calculated after operation of the coloring nozzle set 62 is stopped. If the fixed time is later than the time when the printing mode is ended, the predetermined time is the fixed time. If the fixed time is earlier than the time when the printing mode is ended, the predetermined time is the time when the printing mode is ended. For example, the fixed time is 10 seconds after the coloring nozzle set 62 stops operating, if it takes 10 seconds for the exhaust fan structure 7 to draw the excess powder generated by the coloring nozzle set 62 to the outside of the housing 1 after operation of the coloring nozzle set 62 is stopped. But the printing mode is ended after 9 seconds after the coloring nozzle set 62 finishes printing. Since the fixed time is later than the time when the printing mode is ended, the predetermined time is the fixed time, i.e. 10 seconds after the coloring nozzle set 62 stops operating. In contrast, if the printing mode is ended after 11 seconds after the coloring set 62 finishes printing, in that case, because the fixed time is earlier than the time when the printing mode is ended, the predetermined time is the time when the printing mode is ended, i.e. 11 seconds after the coloring nozzle set 62 finishes printing. Please be noted that, the description mentioned above is only an example describing how to calculate the determined time, but the fixed time and the predetermined time are not limited to any specified amount of time.

A description about the second embodiment for carrying out the printing mode is provided below. The printing mode includes, by using the controller 8, controlling the formation nozzle member 61 and the coloring nozzle set 62 to perform three-dimensional printing, keeping the exhaust fan structure 7 in operation, and activating the formation platform 9. However, ending of the printing mode does not include activating or stopping the formation nozzle member 61 and does not include making the formation platform 9 return. It is because the target of the present disclosure is to prevent the powder from being discharged to the outside of the housing, and therefore, in the second embodiment, ending of the printing mode does not need to consider whether to activate the formation nozzle member 61 or not, and also does not need to consider whether to make the formation platform 9 return or not.

To be specific, in the second embodiment, when the printing mode is ended, the controller 8 only controls the coloring nozzle set 62 to stop operation, but the formation nozzle member 61 and the formation platform 9 can keep operating. From when the coloring nozzle set 62 stops operating to the predetermined time, the controller 8 controls the exhaust fan structure 7 to keep operative, so that the powder inside the housing 1 is continuously discharged to the outside of the housing 1 by the exhaust fan structure 7. At last, the unlocking mode is activated after the predetermined time after the coloring nozzle set 62 stops operating. In the unlocking mode, the controller 8 controls the actuator 5 to drive the door lock structure 4 to release the door panel 2, so that the door panel 2 can be moved to the open position. Compared to the printing mode of the first embodiment, the printing mode of the second embodiment is different in that, the door lock structure 4 releases the door panel 2 when the coloring nozzle set 62 stops operating, although the formation nozzle member 61 and the formation platform 9 still keep operating. As a result, when the door panel 2 is opened, the formation nozzle member 61 and the formation platform 9 keep operating.

Furthermore, compared to the printing mode of the first embodiment, the printing mode of the second embodiment is also different in that, the predetermined time is calculated differently. In the second embodiment, the time when the printing mode is ended is the time when the coloring nozzle set stops operating. Therefore, the predetermined time is the fixed time calculated after the coloring nozzle set 62 stops operating. For example, the fixed time is 10 seconds if it takes 10 seconds, after the coloring nozzle set 62 stops operating, for the exhaust fan structure 7 to draw and discharge the powder generated by the coloring nozzle set 62 during printing to the outside of the housing 1. In that case, the predetermined time is the fixed time, i.e. 10 seconds after the coloring nozzle set 62 stops operating. Please be noted that, the description mentioned above is only an example describing how to calculate the determined time, but the fixed time and the predetermined time are not limited to any specified amount of time.

In summary, the three-dimensional printer having the door lock structure is neither disclosed by similar products nor used in public. The present disclosed example also has industrial applicability, novelty and non-obviousness, so the present disclosed example completely complies with the requirements of patentability. Therefore, a request to patent the present disclosed example is filed pursuant to patent law. Examination is kindly requested, and allowance of the present application is solicited to protect the rights of the inventor.

What is claimed is:

1. A three-dimensional printer having a door lock structure, comprising:
a housing, the housing including a chamber inside and an opening communicating with the chamber;
a door panel pivotally connected to the housing, the door panel being movable between a closed position which closes the opening and an open position which exposes the opening;
a door lock structure disposed corresponding to the door panel, the door lock structure including a locking position and an unlocking position;
an actuator connected to the door lock structure and driving the door lock structure to lock or unlock the door panel;
a formation nozzle member installed in the chamber and being movable therein, the formation nozzle member printing a laminated object;
a coloring nozzle set installed in the chamber and being movable therein, the coloring nozzle set coloring the laminated object;
an exhaust fan structure assembled to the housing and communicating with the chamber, the exhaust fan structure drawing air from the housing and discharging the air to the outside of the housing; and
a controller electrically connected the actuator, the formation nozzle member, the coloring nozzle set, and the exhaust fan structure, wherein the controller controls the actuator to drive the door lock structure to the locking position; when the door panel is at the closed position, the door lock structure locks the door panel, and the controller is allowed to activate a printing mode; the printing mode including, by using the controller, controlling the formation nozzle member and the coloring nozzle set to perform three-dimensional printing and controlling the exhaust fan structure to keep operating; the controller activates an unlocking mode after a predetermined time if the controller determines that operation of the coloring nozzle set is stopped; and in the unlocking mode, the controller controls the actuator to drive the door lock structure to the unlocking position to release the door panel.

2. The three-dimensional printer having the door lock structure according to claim 1, wherein a fixed time is calculated after operation of the coloring nozzle set is stopped, and the predetermined time is the fixed time.

3. The three-dimensional printer having the door lock structure according to claim 2, wherein when the printing mode is ended, the controller controls the coloring nozzle set to stop operation, and the controller controls the exhaust fan structure to keep operating from when the printing mode is ended to the predetermined time.

4. The three-dimensional printer having the door lock structure according to claim 1, further comprising a formation platform, the formation platform being assembled in the chamber and electrically connected to the controller, the printing mode further including, by using the controller, controlling the formation platform to move from an original position; wherein after the printing mode is ended, the controller controls the formation nozzle member and the coloring nozzle set to stop operating; the controller controls the formation platform to return to the original position, and the controller controls the exhaust fan structure to keep operative from when the printing mode is ended to the predetermined time.

5. The three-dimensional printer having the door lock structure according to claim 4, wherein a fixed time is calculated after operation of the coloring nozzle set is stopped; the predetermined time is the fixed time if the fixed time is later than the time when the printing mode is ended; and the predetermined time is the time when the printing mode is ended if the fixed time is earlier than the time when the printing mode is ended.

6. The three-dimensional printer having the door lock structure according to claim 1, wherein the controller controls the exhaust fan structure to stop operating after the predetermined time after operation of the coloring nozzle set is stopped.

7. The three-dimensional printer having the door lock structure according to claim 1, further comprising a door panel sensor, the door panel sensor being disposed corresponding to the door panel and electrically connected to the controller, the door panel sensor generating a response signal if the door panel sensor senses that the door panel is at the closed position, the controller controlling the actuator to drive the door lock structure to lock the door panel when the controller receives the response signal.

8. The three-dimensional printer having the door lock structure according to claim 1, wherein the door lock structure includes a lock hole element fixed to the door panel and includes a latch structure fixed to the housing, the lock hole element includes a lock hole, the latch structure includes a pivot member, the actuator drives the pivot member to be inserted in the lock hole to lock the door panel, the actuator drives the pivot member to be detached from the lock hole to thereby release the door panel, the locking position is a position which inserts the pivot member into the lock hole, and the unlocking position is a position which detaches the pivot member from the lock hole.

9. The three-dimensional printer having the door lock structure according to claim 8, wherein a block plate extends from one side of the opening of the housing, the door panel is blocked by the block plate, and the door panel sensor is fixed to the block plate.

10. The three-dimensional printer having the door lock structure according to claim 9, wherein the latch structure is fixed to the block plate.

11. The three-dimensional printer having the door lock structure according to claim 1, further including a drive base, wherein the drive base is installed in the chamber and movable therein, and the formation nozzle member and the coloring nozzle set are fixed to the drive base, so that the formation nozzle member and the coloring nozzle set are movable along with the drive base.
